(19) United States
(12) Patent Application Publication
(10) Pub. No.: US 2011/0004699 A1
(43) Pub. Date: Jan. 6, 2011

(54) METHOD, SYSTEM AND SESSION CONTROL UNIT FOR RELIEVING NETWORK TRAFFIC

(75) Inventors: Lei HAN, Shenzhen (CN); Yue Yin, Shenzhen (CN); Feng Li, Shenzhen (CN)

Correspondence Address: STAAS & HALSEY LLP, SUITE 700, 1201 NEW YORK AVENUE, N.W., WASHINGTON, DC, 20005, US

(73) Assignee: HUAWEI TECHNOLOGIES CO., LTD., Shenzhen (CN)

(21) Appl. No.: 12/880,397

(22) Filed: Sep. 13, 2010

Related U.S. Application Data
(63) Continuation of application No. PCT/CN2009/070678, filed on Mar. 9, 2009.

(30) Foreign Application Priority Data
Mar. 14, 2008 (CN) 200810085045.8

(51) Int. Cl. G06F 15/16

(52) U.S. Cl. 709/235

(57) ABSTRACT

The present invention relates to the Internet field, and discloses a method, system and session control unit for relieving network traffic. The method includes: receiving a content request message; searching a network for data corresponding to content requested by the content request message, and selecting a content replication point according to a search result; and instructing the selected content replication point to replicate and forward the data to a requesting node. The session control unit includes a receiving unit, a searching unit, a selecting unit, and an instruction sending unit. The system includes a session control unit and a content replication point. In the technical solution under the present invention, a content replication point is selected intelligently by identifying the user request information, and the selected content replication point is responsible for replicating and forwarding the data, thus relieving the network traffic and load.

### CROSS-REFERENCE TO RELATED APPLICATIONS

This application is a continuation of International Application No. PCT/CN2009/070678, filed on Mar. 9, 2009, which claims priority to Chinese Patent Application No. 200810085045.8, filed on Mar. 14, 2008, both of which are hereby incorporated by reference in their entireties.

### FIELD OF THE INVENTION

The present invention relates to the Internet field, and in particular, to a method, system and session control unit for relieving network traffic.

### BACKGROUND OF THE INVENTION

Currently, the Internet bears a variety of services such as video, voice, game, e-commerce, and instant messaging, which constitute different data transmitted on the network. Especially, with the popularity of multimedia services, the multimedia data that occupies high bandwidth on the network increases the network traffic and load greatly.

To relieve the network traffic and load, the prior art provides an Internet Protocol (IP) multicast technology, as shown in FIG. 1.

In FIG. 1, terminal A is connected to a network access point B, and belongs to group 1. Group 1 is labeled by a separate IP address. If terminal B needs to obtain the same data as terminal A receives, terminal B needs to know, by means other than IP multicast, that terminal B itself should join group 1, and then send a multicast join request to the network access point B to request to join group 1. The network access point B accepts the request, and replicates and forwards the corresponding data to terminal B.

In the process of implementing the present invention, the inventor finds at least the following problems in the prior art:

The existing IP multicast technology replicates and forwards data only according to the multicast address, without caring about forwarded content. The multicast address needs to be mapped and bound to the content through a third-party method (such as manual configuration), which increases the system complexity.

### SUMMARY OF THE INVENTION

Embodiments of the present invention provide a method, system and session control unit for relieving network traffic to relieve the network traffic and load. The technical solution under the present invention is as follows:

A method for relieving network traffic includes:

receiving a content request message;

searching a network for data corresponding to content requested by the content request message, and selecting a content replication point according to a search result; and

instructing the selected content replication point to replicate and forward the data to a requesting node.

A session control unit includes:

a receiving unit, adapted to receive a content request message;

a searching unit, adapted to search a network for data corresponding to content requested by the content request message;

a selecting unit, adapted to select a content replication point according to a search result of the searching unit; and

an instruction sending unit, adapted to instruct the selected content replication point to replicate and forward the data to a requesting node.

A system for relieving network traffic includes:

a session control unit, adapted to: receive a content request message, search a network for data corresponding to content requested by the content request message, select a content replication point according to a search result, and instruct the selected content replication point to replicate and forward the data to a requesting node; and

the content replication point, adapted to replicate and forward the data to a requesting node according to the instruction.

In the embodiments of the present invention, a content replication point is selected intelligently by identifying the user request information, and the selected content replication point is responsible for replicating and forwarding the data, thus relieving the network traffic and load.

### BRIEF DESCRIPTION OF THE DRAWINGS

FIG. 1 is an IP multicast networking diagram in the prior art;

FIG. 2 is a networking diagram of a method for relieving network traffic in an embodiment of the present invention;

FIG. 3 is a networking diagram of another method for relieving network traffic in an embodiment of the present invention;

FIG. 4 is a flowchart of a method for relieving network traffic in an embodiment of the present invention;

FIG. 5 is a flowchart of another method for relieving network traffic in an embodiment of the present invention;

FIG. 6 shows composition of a session control unit in an embodiment of the present invention; and

FIG. 7 shows a system for relieving network traffic in an embodiment of the present invention.

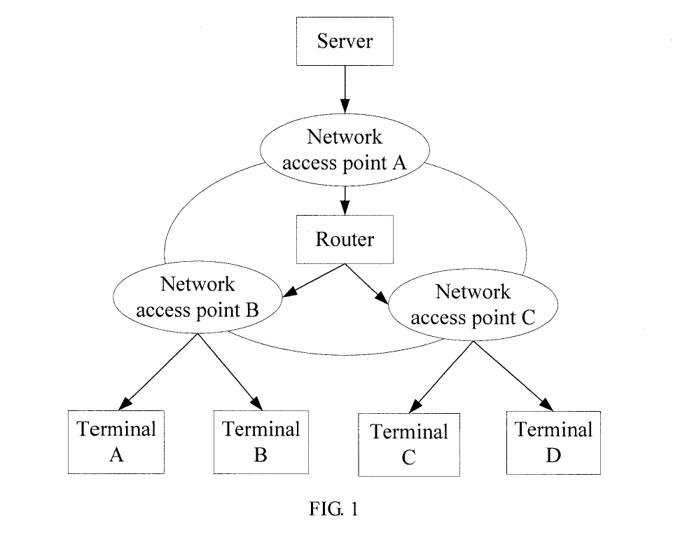

### DETAILED DESCRIPTION OF THE EMBODIMENTS

To make the technical solution, objectives and merits of the present invention clearer, the following describes the embodiments of the present invention in more detail with reference to accompanying drawings.

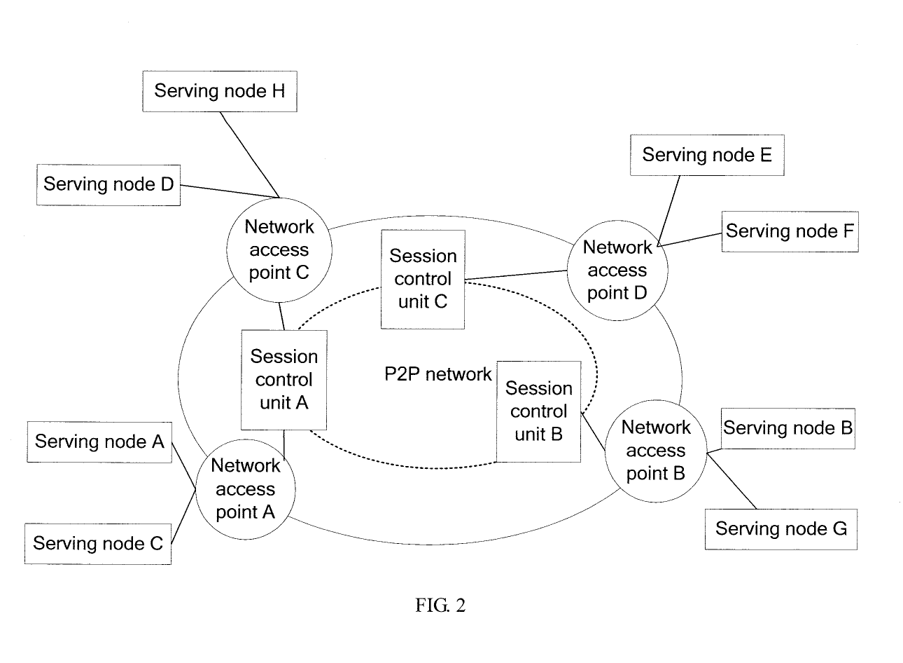

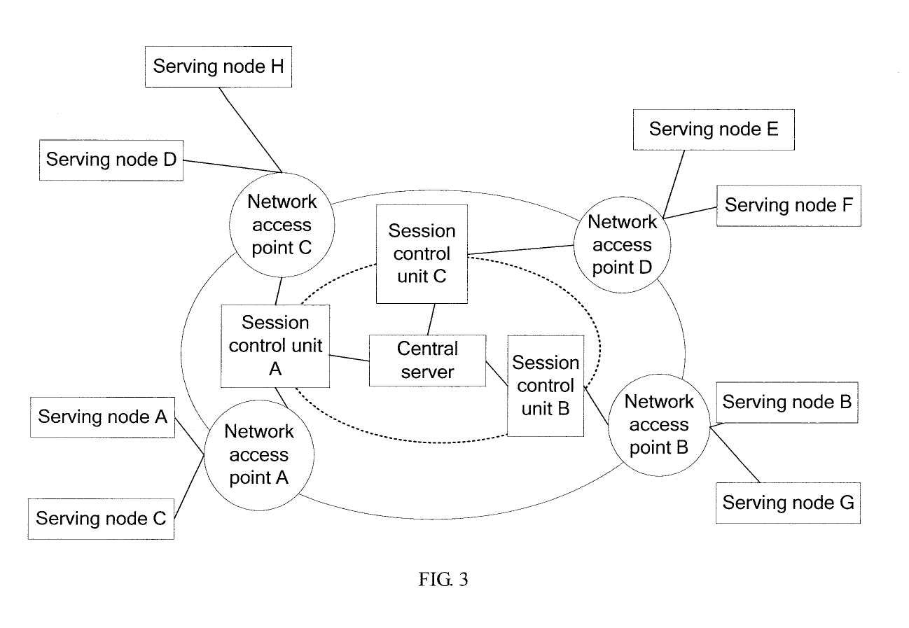

Through a method for relieving network traffic in an embodiment of the present invention, a network device is selected intelligently by identifying the user request information, and the selected network device is responsible for replicating and forwarding the data, thus relieving the network traffic and load effectively. As shown in FIG. 2 and FIG. 3, the method in this embodiment includes the following steps:

Step 1: A serving node B sends information that it owns movie Q to a network access point B.

The information about that the serving node B owns movie Q includes two parts:

One part is the information about movie Q, and may be the movie name “Q” only or other information such as the version number and publisher of the movie in addition to the movie name. For brevity, it is assumed in this embodiment that the information about movie Q includes the movie name “Q” only.

The other part is the identifier of the serving node, which may be an IP address, or a Media Access Control (MAC) address.

Step 2: The network access point B sends the received information to a session control unit B. The information carries the identifier of the network access point B.

Step 3: The session control unit B receives the information sent by the network access point B, and converts the movie name “Q” in the information into a key through a hash algorithm. The session control unit B records the binding relation between the key and the identifier of the serving node B into a local database, and publishes the binding relation between the key and the session control unit B onto the network.

There are two publishing modes:

The first publishing mode is: The session control unit B stores the binding relation between the key and the identifier of the session control unit B onto a session control unit obtained according to a P2P routing algorithm. As shown in FIG. 2, all the session control units compose a P2P network. The session control unit B stores the binding relation between the key and the identifier of the session control unit B onto a session control unit A and the session control unit B obtained according to a P2P routing algorithm.

The second publishing mode is: The session control unit B stores the binding relation between the key and the identifier of the session control unit B onto a central server, as shown in FIG. 3.

Besides, in step 2, because the network access point B sends its identifier to the session control unit B, the session control unit B may perceive the network topology relation between the network access point B and requesting node B.

Step 4: A requesting node A sends a request for obtaining movie Q to network access point A.

The request for obtaining movie Q may include movie name “Q” only or other information such as the version number and publisher of the movie in addition to the movie name. For brevity, it is assumed in this embodiment that the request for obtaining movie Q includes the movie name “Q” only.

Step 5: A network access point A receives the request for obtaining movie Q and forwards the request to session control unit A. The request carries the identifier of network access point A.

Step 6: The session control unit A receives the request, converts the movie name “Q” in the request into a key through a hash algorithm, performs route query according to the key and finds that a node connected to the session control unit B owns movie Q, and therefore, sends the request for obtaining movie Q to the session control unit B. The request carries the key.

The route query is performed in two modes:

(1) The session control unit A performs route query according to the key by using the existing route query algorithm, and knows that the node connected to the session control unit B owns movie “Q”, as shown in FIG. 2.

(2) The session control unit A sends a query request to the central server according to the key to find the node that owns movie Q in the network, as shown in FIG. 3.

In step 5, because the network access point A adds its identifier to the request directed to session control unit A, the session control unit A may perceive the topology relation between the network access point A and the requesting node A.

Step 7: After receiving the request, the session control unit B searches the local database according to the key in the request, and finds that the serving node B owns movie Q. Therefore, the session control unit B sends the request for obtaining movie Q to the serving node B.

Because the database of the session control unit B stores the binding relation between the key and the identifier of the serving node B, the session control unit B can know the node that owns the data desired by the user according to the key.

Step 8: After receiving the request, the serving node B sends movie Q to the requesting node A through the network access point B and the network access point A according to the movie name “Q” in the request.

Step 9: The session control unit records the transmission information in its database.

The database of the session control unit A records the information about transmitting movie Q from network access point A, and the database of the session control unit B records the information about transmitting movie Q from the network access point B.

The following describes this embodiment in more detail with respect to the same request in this domain, and the same request in other domains. The same request in this domain refers to the same request under the same network access point; and the same request in other domains refers to the same request under different network access points.

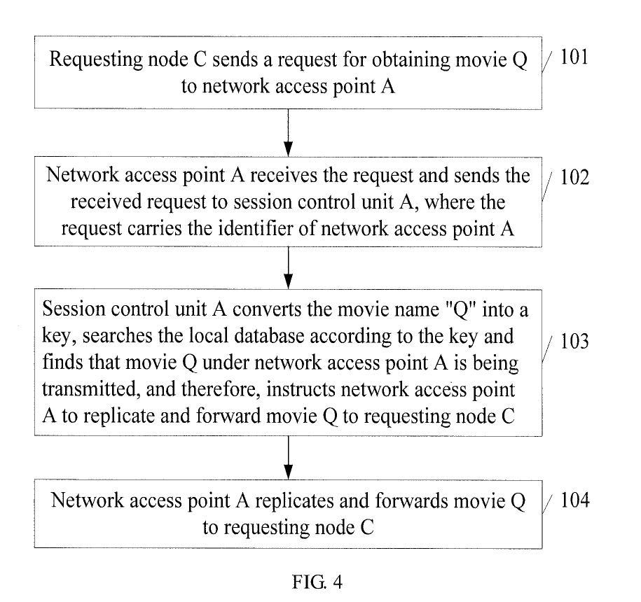

As shown in FIG. 4, the method for replicating and forwarding data with respect to the same request in this domain includes the following steps:

Step 101: A requesting node C sends a request for obtaining movie Q to network access point A.

The request for obtaining movie Q may include movie name “Q” only or other information such as the version number and publisher of the movie in addition to the movie name. For brevity, it is assumed in this embodiment that the request for obtaining movie Q includes the movie name “Q” only.

Step 102: A network access point A sends the received request to session control unit A. The request carries the identifier of network access point A.

Step 103: A session control unit A receives the request for obtaining movie Q from network access point A, converts the movie name “Q” into a key through a hash algorithm, and searches the local database to find that movie Q with the same key is already transmitted on the network through network access point A. Therefore, the session control unit A sends a success response to serving node C through network access point A, and sends an instruction to network access point A. The instruction instructs the network access point A to replicate movie Q and send the replicated data to serving node C.

In step 102, because the network access point A sends its identifier to session control unit A, the session control unit A can perceive the network topology relation between the network access point A and the requesting node C.

Step 104: After receiving the instruction of session control unit A, the network access point A replicates movie Q, and sends the replicated data to the requesting node C.

The session control unit A records the following information in the local database: the number of nodes that are receiving data of movie Q under network access point A, so that the data streams of movie Q will be disconnected when no receiving node exists under network access point A; a session control unit B records the following information in the local database: the number of copies of data of movie Q being transmitted by a network access point B, so that the data streams of movie Q will be disconnected when no receiving node exists.

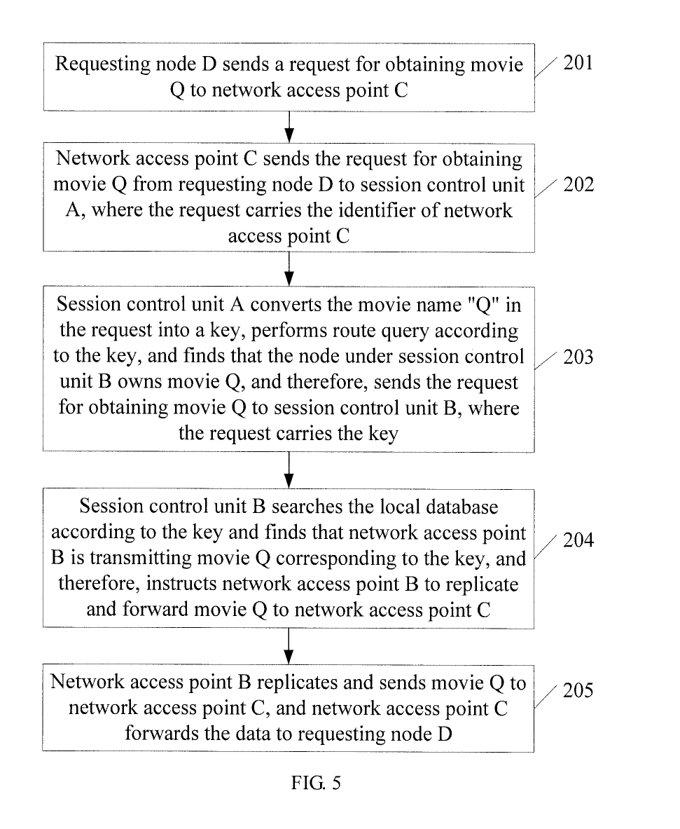

As shown in FIG. 5, the method for replicating and forwarding data with respect to the same request in other domains includes the following steps:

Step 201: Requesting node D sends a request for obtaining movie Q to a network access point C.

The details are the same as step 101 above.

Step 202: The network access point C sends the request for obtaining movie Q to session control unit A. The request carries the identifier of the network access point C.

Step 203: After receiving the request, a session control unit A converts the movie name “Q” into a key through a hash algorithm, and searches the local database to find that the network access point C is not transmitting any movie Q corresponding to the same key. Therefore, the session control unit A performs route query according to the key and knows that a node under a session control unit B owns movie Q, and sends a request for obtaining movie Q to the session control unit B. The request carries the key.

The route query mode is similar to the query mode in step 6, and is not further described.

In step 202, because the network access point C sends its identifier to session control unit A, the session control unit A can perceive the network topology relation between the network access point C and requesting node D.

Step 204: The session control unit B searches the local database according to the key in the received request, and finds that the network access point B is transmitting movie Q corresponding to the key. Therefore, the session control unit B sends an instruction to network access point B, instructing network access point B to replicate movie Q and send the replicated data to network access point C.

Step 205: After receiving the instruction of the session control unit B, network access point B replicates movie Q, and sends the replicated data to network access point C. A network access point C forwards the data to requesting node D.

The session control unit A records the following information in the local database: the number of nodes that are receiving data of movie Q under the network access point C, so that the data streams of movie Q will be disconnected when no receiving node exists under the network access point C; the session control unit B records the following information in the local database: the number of copies of data of movie Q being transmitted by the network access point B, so that the data streams of movie Q will be disconnected when no receiving node exists.

In step 203, the session control unit A performs route query according to the key and finds that a node under the session control unit B owns movie Q, and sends a request for obtaining movie Q to the session control unit B. The request may carry no key. Accordingly, in step 204, the session control unit B converts the movie name “Q” in the received request into a key through a hash algorithm, and queries the local database according to the key to check whether the network access point B is transmitting movie Q; if so, the session control unit B instructs the network access point B to replicate and forward movie Q to requesting node D.

In this embodiment, the session control unit may be stand-alone or integrated with another device such as a router or a server.

In this embodiment, the session control unit selects the content replication point intelligently by identifying the user request information, and the selected content replication point replicates and forwards the data, thus relieving the network traffic and load. The content replication point may be any network access point, for example, the network access point A in FIG. 2 or FIG. 3, or the network access point B, or the network access point C, or a network access point D.

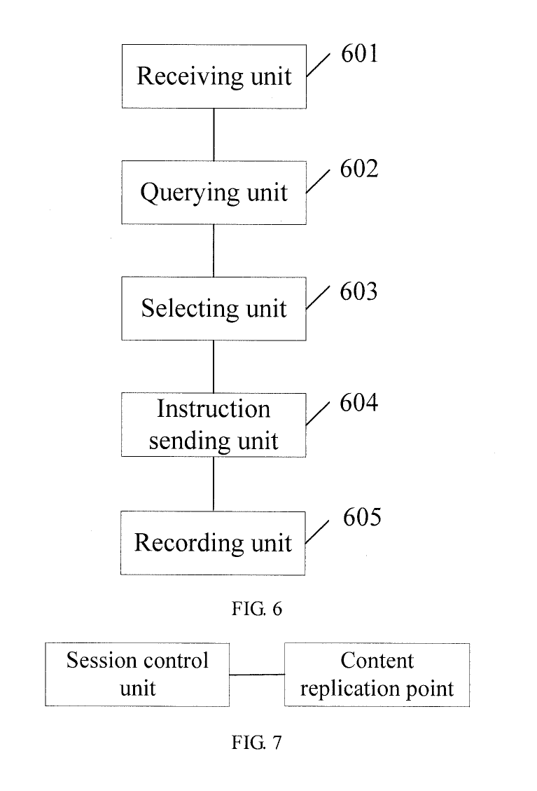

A session control unit is provided in an embodiment of the present invention. As shown in FIG. 6, the session control unit includes:

a receiving unit 601, adapted to receive a content request message;

a searching unit 602, adapted to search a network for data corresponding to content requested by the content request message;

a selecting unit 603, adapted to select a content replication point according to a search result of the searching unit 602; and

an instruction sending unit 604, adapted to instruct the selected content replication point to replicate and forward the data to a requesting node.

The searching unit 602 includes:

a converting unit, adapted to convert the content requested by the content request message into a key according to a preset algorithm; and

a judging unit, adapted to judge whether any data corresponding to the key exists in the network.

Further, the session control unit may include:

a publishing unit, adapted to publish a binding relation between the session control unit and the content requested by the content request message in the network.

Alternatively, the session control unit may include:

a route querying unit, adapted to perform route query according to the content requested by the content request message.

Finally, the session control unit may further include:

a recording unit 605, adapted to record information about the network access point replicating and forwarding the data to the requesting node.

In this embodiment, the session control unit may be stand-alone or integrated with another device such as a router or a server.

The functions of the session control unit are detailed in the corresponding part of the method embodiment above, and are not further described here.

In this embodiment, the session control unit selects a content replication point intelligently by identifying the user request information, and the selected content replication point is responsible for replicating and forwarding the data, thus relieving the network traffic and load.

A system for relieving network traffic is provided in an embodiment of the present invention. As shown in FIG. 7, the system may include:

a session control unit, adapted to: receive a content request message, search a network for data corresponding to content requested by the content request message, select a content replication point according to a search result, and instruct the selected content replication point to replicate and forward the data to a requesting node; and

a content replication point, adapted to replicate and forward the data to a requesting node according to the instruction.

In this embodiment, the session control unit may be stand-alone or integrated with another device such as a router or a server.

The functions of the session control unit are detailed in the corresponding part of the method embodiment above, and are not further described here.

The content replication point may be any network access point, for example, the network access point A in FIG. 2 or FIG. 3, or the network access point B, or the network access point C, or a network access point D.

The technical solution in this embodiment takes the process of replicating and forwarding a movie as an example. In practical applications, the data type is not limited to movies, but may be audio files, software, or other data types.

In this embodiment, the system selects a content replication point intelligently by identifying the user request information, and the selected content replication point is responsible for replicating and forwarding the data, thus relieving the network traffic and load.

Persons of ordinary skill in the art should understand that all or part of the steps of the method in the embodiments of the present invention may be implemented by a program instructing relevant hardware. The program may be stored in a computer readable storage medium. The storage medium may be a Read-Only Memory (ROM), a Random Access Memory (RAM), a magnetic disk, or a Compact Disk-Read-Only Memory (CD-ROM).

Although the invention is described through some exemplary embodiments, the invention is not limited to such embodiments. It is apparent that those skilled in the art can make modifications and variations to the invention without departing from the spirit and scope of the invention. The invention is intended to cover the modifications and variations provided that they fall within the scope of protection defined by the following claims or their equivalents.

1. A method for relieving network traffic, comprising:
receiving a content request message;
searching a network for data corresponding to content requested by the content request message, and selecting a content replication point according to a search result; and
instructing the selected content replication point to replicate and forward the data to a requesting node.

2. The method according to claim 1, wherein the step of searching the network for the data corresponding to the content requested by the content request message is:
converting the content requested by the content request message into a key, and checking whether any data corresponding to the key exists in the network.

3. The method according to claim 2, wherein the step of checking whether any data corresponding to the key exists in the network comprises:
checking whether a central server stores the key and whether a serving node corresponding to the key exists; or
checking whether a session control unit stores the key and whether the serving node corresponding to the key exists, wherein the session control unit composes the network.

4. The method according to claim 1, further comprising:
publishing a binding relation between a session control unit and the content requested by the content request message in the network.

5. The method according to claim 4, wherein the step of publishing the binding relation between the session control unit and the content requested by the content request message in the network comprises.
converting the content requested by the content request message provided by a serving node into a key according to a preset algorithm;
recording a mapping relation between the key and the serving node; and
publishing a binding relation between the key and the session control unit in the network.

6. The method according to claim 1, wherein the step of selecting the content replication point according to the search result comprises:
judging whether a network access point of the requesting node has sent the data to other requesting nodes connected to the network access point; if so, determining that the network access point of the requesting node is the content replication point; if not, searching for a session control unit corresponding to the data, searching for another network access point capable of providing the data through the session control unit, and determining the other network access point as the content replication point.

7. The method according to claim 1, wherein after instructing the content replication point to replicate and forward the data to the requesting node, the method further comprises:
recording information about the content replication point replicating and forwarding the data to the requesting node.

8. A session control unit, comprising:
a receiving unit, adapted to receive a content request message;
a searching unit, adapted to search a network for data corresponding to content requested by the content request message;
a selecting unit, adapted to select a content replication point according to a search result of the searching unit; and
an instruction sending unit, adapted to instruct the selected content replication point to replicate and forward the data to a requesting node.

9. The session control unit according to claim 8, wherein the searching unit further comprises:
a converting unit, adapted to convert the content requested by the content request message into a key according to a preset algorithm; and
a judging unit, adapted to judge whether any data corresponding to the key exists in the network.

10. The session control unit according to claim 8, further comprising:
a publishing unit, adapted to publish a binding relation between the session control unit and the content requested by the content request message in the network.

11. The session control unit according to claim 8, further comprising:
a route querying unit, adapted to perform route query according to the content requested by the content request message.

12. The session control unit according to claim 8, further comprising:
a recording unit, adapted to record information about the network access point replicating and forwarding the data to the requesting node.

13. A system for relieving network traffic, comprising:
a session control unit, adapted to: receive a content request message, search a network for data corresponding to content requested by the content request message, select a content replication point according to a search result, and instruct the selected content replication point to replicate and forward the data to a requesting node; and
the content replication point, adapted to replicate and forward the data to the requesting node according to the instruction.
